(19) United States
(12) Patent Application Publication
(10) Pub. No.: US 2026/0010529 A1
(43) Pub. Date: Jan. 8, 2026

(54) PLATFORM FOR DATA OBSERVATION IN CONSTRUCTING LARGE-SCALE DATABASE

(71) Applicant: Rakuten Group, Inc., Tokyo (JP)

(72) Inventors: Sivananth THARMARAJ, Tokyo (JP); Vishnu SUBBIAN NADAR RAJENDRAN, Tokyo (JP); Venkata Keerthana KUNCHAM, Tokyo (JP); Vinay JAIN, Tokyo (JP); Yoshiaki KUNO, Tokyo (JP)

(73) Assignee: Rakuten Group, Inc., Tokyo (JP)

(21) Appl. No.: 19/260,955

(22) Filed: Jul. 7, 2025

(30) Foreign Application Priority Data
Jul. 8, 2024 (JP) 2024-109296

(51) Int. Cl. G06F 16/23

(52) U.S. Cl. CPC G06F 16/2365

(57) ABSTRACT

There is provided an information processing apparatus capable of making the accuracy and behavior of data observable when constructing and updating a database by aggregating data from multiple data sources so as to improve data accuracy and availability. The apparatus includes a data set extraction unit configured to extract a data set from a plurality of databases belonging to a plurality of platforms, respectively, a quality analysis unit configured to analyze quality of the data set per data set by applying a first metric to the data set; a data validation unit configured to validate a data value per data item in the data set by applying a second metric to the data set; and a metric construction unit configured to dynamically construct at least a part of the first and second metrics to be applied to the data set based on a processing history of the data set.

### CROSS REFERENCE TO RELATED APPLICATIONS

This application is related to and claims priority under 35 U.S.C. 119 (a) to Japanese patent application No. 2024-109296, filed on Jul. 8, 2024, of which disclosure including the specification, drawings and abstract is incorporated herein by reference in its entirety.

### FIELD

The present disclosure relates to a platform for data observation in constructing a large-scale database, and in particular, to techniques for observing data to be stored in a database in a workflow for constructing and updating a database by extracting data from data sources.

### BACKGROUND

Electronic commerce (EC) platforms accumulate a vast amount of data on a daily basis from customers who use the EC sites offered on the platforms. Such customer data, which includes each customer's attributes and behavior history on the EC sites, is scattered across multiple data platforms, both in the cloud and on-premise, and is constantly being added to and updated.

A large number of customers' data residing in those multiple data platforms can be aggregated, and data sets can be extracted from the aggregated data to build an integrated database of customers.

Referring to the integrated database of customers constructed in this way, a large number of customers can be modeled in clusters, for example, for analysis and prediction of the behavior and the persona of each of the modeled clusters. As an example of use cases, providing personalized advertisements directed to such a modeled cluster can be expected to improve advertising effectiveness as indicated by the conversion rate (CVR) and other indicators.

Patent Literature 1 discloses a data analysis apparatus that analyzes records of customer behavior history to extract prospective customers through the exhaustive trial-and-error processes.

More specifically, the data analysis apparatus disclosed in Patent Literature 1 includes a comparison unit that exhaustively compares customer data concerning customers in a desirable state with customer data concerning customers in an undesirable state based on parameters of customer behavior, which are decisive factors affecting whether the customers are in a desirable state as customers, and a prospective customer/basis extraction unit that obtains, based on the comparison results in the comparison unit, at least one of a prospective customer and a prospective basis for the parameters from among the customers in an undesirable state.

Meanwhile, the integrated database of customers as described above has a vast amount of data, has many interrelated tables with many columns each, and has a complex data structure. Furthermore, since data is being added and updated at a high frequency in each of the multiple data platforms that serve as data sources, the amount and range of data in the data sets extracted from the data sources also fluctuate at high frequencies in accordance with changes in the data sources.

### LISTING OF REFERENCES

### Patent Literature

Patent Literature 1: Japanese Laid-open Patent Application No. 2015-135616 A

### SUMMARY

### Technical Problem to be Solved

Here, data sets extracted from data sources scattered across multiple data platforms inevitably contain errors. Such errors include data that partially contains incorrect values or data types, missing data, duplicate data, and so on.

In order to avoid the loss of data accuracy stored in the integrated database and system downtime caused by the occurrence of such errors, a certain scheme is required to filter out such errors that should not be stored in the integrated database when processing the data sets.

However, as described above, the amount and range of data fluctuate at high frequencies in the data sets extracted from the data sources, in accordance with changes in the data sources. For this reason, if the evaluation criteria for filtering errors are uniform and unchanged, the data sets cannot follow those changes, resulting in the reduced accuracy of the data stored in the integrated database of customers.

On the other hand, when the error evaluation criteria for each of the multiple data platforms, which serve as data sources, are to be reflected whenever necessary for filtering errors, the system inevitably becomes more complex, and a delay occurs every time reflecting the error evaluation criteria. In any case, it would be not easy to monitor and maintain the accuracy of the data in the entire integrated database.

Therefore, the present disclosure was made to solve the above problems, and the object thereof is to provide information processing apparatus, information processing method, and program thereof that make the accuracy and behavior of data from multiple data sources observable when constructing and updating a database by aggregating data from multiple data sources, thereby improving the accuracy and availability of the data.

### Solution to Problems

In order to solve the above described problems, according to one aspect of the present disclosure, there is provided an information processing apparatus, comprising: a data set extraction unit configured to extract a data set from a plurality of databases belonging to a plurality of platforms, respectively; a quality analysis unit configured to analyze quality of the data set per data set by applying a first metric to the data set; a data validation unit configured to validate a data value per data item in the data set by applying a second metric to the data set; and a metric construction unit configured to dynamically configure at least a part of the first metric and the second metric to be applied to the data set based on a processing history of the data set.

According to another aspect of the present disclosure, there is provided an information processing method performed by an information processing apparatus, comprising steps of: extracting a data set from a plurality of databases belonging to a plurality of platforms, respectively; analyzing quality of the data set per data set by applying a first metric to the data set; validating a data value per data item in the data set by applying a second metric to the data set; and dynamically configuring at least a part of the first metric and the second metric to be applied to the data set based on a processing history of the data set.

According to yet another aspect of the present disclosure, there is provided a non-transitory computer-readable medium having recorded thereon an information processing program for causing a computer to perform information processing, the program causing the computer to perform: a data set extraction process of extracting a data set from a plurality of databases belonging to a plurality of platforms, respectively; a quality analysis process of analyzing quality of the data set per data set by applying a first metric to the data set; a data validation process of validating a data value per data item in the data set by applying a second metric to the data set; and a metric construction process of dynamically configuring at least a part of the first metric and the second metric to be applied to the data set based on a processing history of the data set.

### Advantageous Effects

According to one aspect of the present disclosure, it makes it possible to make the accuracy and behavior of data from multiple data sources observable when constructing and updating a database by aggregating data from multiple data sources, thereby improving the accuracy and availability of the data.

The above mentioned and other not explicitly mentioned objects, aspects and advantages of the present invention will become apparent to those skilled in the art from the following embodiments (detailed description) of the invention by referring to the accompanying drawings and the appended claims.

### BRIEF DESCRIPTION OF DRAWINGS

Features, aspects, and advantages of embodiments of the present disclosure are illustrated below with reference to the accompanying drawings. The same reference numerals in the drawings represent the same elements.

FIG. 1 is a block diagram illustrating an exemplary functional configuration of a data observation apparatus according to respective embodiments of the present invention.

FIG. 2 is a block diagram illustrating an exemplary workflow configuration when the data observation apparatus according to a present embodiment is implemented in an integrated database construction workflow.

FIG. 3 is a flowchart illustrating an exemplary detailed processing procedure of the data quality check processing performed by the data observation apparatus according to the present embodiment.

FIG. 4 is a diagram illustrating an example of a screen displaying the results of the freshness check processing, which is output to a client device via the UI in step S32 of FIG. 3.

FIG. 5 is a diagram illustrating an example of a screen displaying the results of the volume check processing, which is output to the client device via the UI in step S33 of FIG. 3.

FIG. 6A is a diagram illustrating an example of a screen displaying the results of the data distribution check processing, which is output to the client device via UI in step S34 of FIG. 3.

FIG. 6B is a diagram illustrating an example of a screen displaying other results of the data distribution check processing, which is output to the client device via UI in step S34 of FIG. 3.

FIG. 6C is a diagram illustrating an example of a screen displaying other results of the data distribution check processing, which is output to the client device via UI in step S34 of FIG. 3.

FIG. 7 is a flowchart illustrating an exemplary detailed processing procedure of the data validation check processing performed by the data observation apparatus according to the present embodiment.

FIG. 8 is a flowchart illustrating an exemplary detailed processing procedure of the metric construction processing performed by the data observation apparatus according to the present embodiment.

FIG. 9 is a flowchart illustrating an exemplary detailed processing procedure of the error handling processing performed by the data observation apparatus according to the present embodiment.

FIG. 10 is a diagram illustrating an example of a definition of data quality analysis metrics.

FIG. 11 is a diagram illustrating an example of a definition of data validation metrics.

FIG. 12 is a block diagram illustrating an exemplary hardware configuration of the data observation apparatus according to the present embodiment.

### DETAILED DESCRIPTION

Hereinafter, exemplary embodiments will be described in detail with reference to the accompanying drawings. In the present disclosure, drawings and descriptions are provided but are not intended to be exhaustive or to limit the embodiments to the precise forms disclosed. Modifications and variations are available in light of the present disclosure and may be obtained from implementations of the embodiments. Further, one or more features or components of one embodiment can be incorporated into or combined with another embodiment (or may be incorporated into or combined with one or more features of another embodiment). In addition, flowcharts and descriptions related to operations set forth below relate to at least one of embodiments of the present disclosure. It should be noted, however, that it is also possible to create other embodiments that do not exactly match the flowcharts and their description. It should also be understood that in other embodiments, (although at least in part), one or more operations may be omitted, one or more operations may be added, and one or more operations may be performed simultaneously.

It is evident that a system, method, or both, described in the present specification may be implemented in various forms of hardware, software, or a combination of hardware and software. Also, the actual specialized control hardware or software code used to implement the system, method, or both should not limit their implementation. Therefore, in the present specification, the operation and behavior of the system, method, or both will be described without reference to specific software codes. Furthermore, it should be understood that, based on the description of the present specification, software and hardware may be designed to implement the system, method, or both.

A data observation apparatus according to the present embodiment extracts a data set from a plurality of customer databases, which belong to a plurality of data platforms (hereinafter simply referred to as “platform”), respectively, applies a first metric to the extracted data set to analyze the data set-by-data set quality of the data set (i.e., the quality of the data sets per data set), and applies a second metric to the extracted data sets to validate item-by-item data values in the data set.

The data observation apparatus also dynamically constructs at least a part of the first and second metrics to be applied to the data sets based on the processing history of the data set.

Hereinafter, a non-limiting example will be described in which the data observation apparatus according to the present embodiment extracts a data set from customers' data accumulated on a plurality of platforms, such as the customer's behavior history on EC sites, or the like, and the customer's attributes, and constructs an integrated customer database from the extracted data set, and updates the integrated customer database on a real time basis. However, the present embodiment is not limited thereto.

The present embodiment is equally applicable not only to the customers' data on platforms, but also to any data that is to be aggregated and used for any applications. Also, according to the present embodiment, respective processes are performed in pipeline processing, i.e., extracting a data set from the customers' data, converting the extracted data set to an appropriate format such as a hierarchical table as necessary, and storing the formatted data set in an integrated database. However, the frequency of updating the integrated database constructed in this way may be arbitrary and may vary depending on the data sources and the type of data sets.

### <Functional Configuration of Data Observation Apparatus>

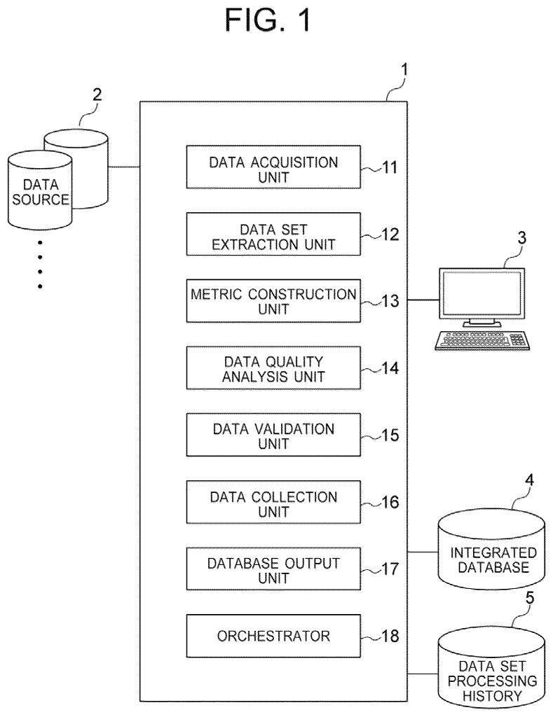

FIG. 1 is a block diagram illustrating an exemplary functional configuration of the data observation apparatus 1. The data observation apparatus 1 shown in FIG. 1 includes a data acquisition unit 11, a data set extraction unit 12, a metric construction unit 13, a data quality analysis unit 14, a data validation unit 15, a data collection unit 16, a database output unit 17, and an orchestrator 18.

The data observation apparatus 1 is configured to have access to respective storage devices of data sources 2 distributed across a plurality of platforms, as well as an integrated database 4 and a data set processing history 5.

The data observation apparatus 1 connects to the data sources 2 distributed across a plurality of platforms, communicates with the connected data sources to read and aggregate customer data stored in storage devices of the data sources, extracts a data set from the aggregated customer data, and constructs the integrated database 4 from the extracted data set(s). The data observation apparatus 1 also stores the processing results obtained by processing the data sets in the data set processing history 5.

The data sources 2, the integrated database 4, and the data set processing history 5 are equipped with storage devices, respectively, which may be constituted with non-volatile storage devices such as HDD (Hard Disk Drive), SSD (Solid State Drive), or the like.

The data observation apparatus 1 may also be equipped with one or more client devices 3 constituted with a PC (Personal Computer) or the like, or may be communicatively connected to the client devices 3 via a network. In this case, the data observation apparatus 1 may be implemented on a server, and the client devices 3 may provide a user interface for the data observation apparatus 1 to perform information input/output with the outside and may also have some or all of the components 11 to 18 of the data observation apparatus 1.

According to the present embodiment, each of client devices 3 may provide a user interface (i.e., UI) for setting and editing various parameters and templates in the data quality check processing and the data validation processing performed by the data observation apparatus 1, as well as a user interface for outputting search results and processing results of the data quality check processing and data validation processing.

The data acquisition unit 11 connects to the data sources 2 distributed across a plurality of platforms, acquires customer data via a communication I/F from the connected data sources 2, and supplies the acquired customer data to the data set extraction unit 12. The data acquisition unit 11 may receive the customer data from each of the data sources 2 of the plurality of platforms on a periodic basis or when an update occurs. Alternatively, the data acquisition unit 11 may periodically issue a query to each of the plurality of data sources 2 and receive the customer data as a response to the issued query.

The data acquisition unit 11 may acquire the customer data by connecting directly to the data sources 2 and reading the customer data previously stored in the storage devices of the data sources 2, or the data acquisition unit 11 may receive the customer data via the same or different counterpart devices that manage the data sources 2.

The data acquisition unit 11 also accepts input of various parameters necessary to perform the data observation processing in the data observation apparatus 1. The data acquisition unit 11 may accept input of various parameters via the user interface of the client devices 3 connected to the data observation apparatus 1.

The customer data acquired by the data acquisition unit 11 typically includes any information associated with the customer's use of E-Commerce sites on the platforms, including the customer's history of searching, browsing, purchasing, and other behaviors on the e-commerce sites, or the like, and the customer's personal or segmental attributes.

The data set extraction unit 12 extracts a data set from the customer data supplied by the data acquisition unit 11 and supplies the extracted data set(s) to the metric construction unit 13, data quality analysis unit 14, and data validation unit 15, which are downstream processes thereof.

A data set extracted by the data set extraction unit 12 is a unit for storing or processing data that is extracted as information to be stored in the integrated database 4 from the customer data acquired by the data acquisition unit 11. According to the present embodiment, the data set includes data describing attributes, properties, structures, meanings, and relationships that represent the customer data, respectively.

According to the present embodiment, a non-limiting example will be described in which the data set extracted by the data set extraction unit 12 includes demographic data as demographic attributes of customers who use e-commerce sites, or the like. The demographic data is demographic attributes used as indicators for analyzing customer data, and more specifically includes gender, age, residential region, occupation, annual income, educational background, family structure, and the like.

The metric construction unit 13 constructs metrics to evaluate the data set(s) extracted by the data set extraction unit 12.

More specifically, the metric construction section 13 dynamically constructs metrics for the data quality analysis unit 14 to analyze the data quality of the data set and metrics for the data validation unit 15 to validate the data set. The former are referred to as data quality analysis metrics and the latter as data validation metrics. The metric construction unit 13 may construct a plurality of data quality analysis metrics and a plurality of data validation metrics, respectively.

The metrics constructed by the metric construction unit 13 are indicators set according to the conditions (or parameters) to be applied in the data quality check performed by the data quality analysis unit 14 and the data validation performed by the data validation unit 15, respectively.

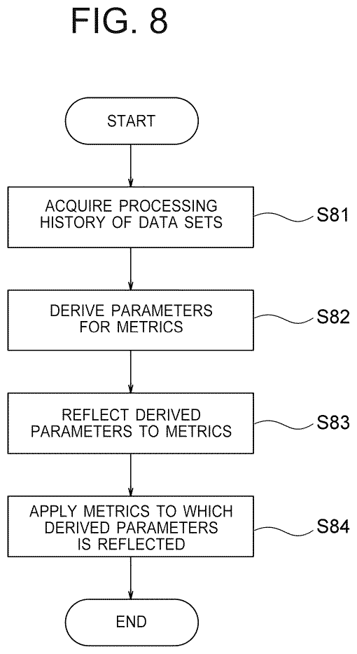

According to the present embodiment, the metric construction unit 13 dynamically constructs metrics to be applied to the next data set to be processed by referring to the processing history 5 of the data set collected by the data collection unit 16, and the details of this metrics construction process will be described below with reference to FIG. 8.

The data quality analysis unit 14 analyzes the quality of the data set by applying the data quality analysis metrics constructed by the metric construction unit 13 to the data set extracted by the data set extraction unit 12.

The data quality analysis metrics to be applied to the data set by the data quality analysis unit 14 are metrics for analysis of the per-data set quality of the data set over time (i.e., metrics for time-series analysis of the quality of the data set per data set).

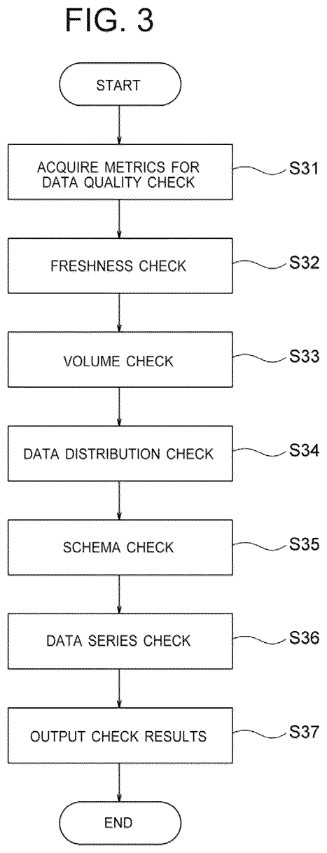

Thus, the data quality analysis unit 14 analyzes the quality of each data set of the data sets. The data quality analysis unit 14 may perform processes of applying a plurality of data quality analysis metrics to the data set in parallel in the pipeline processing. The details of the data quality check processing for analyzing data quality will be described below with reference to FIG. 3.

The data validation unit 15 validates the data set by applying the data validation metrics constructed by the metric construction unit 13 to the data set extracted by the data set extraction unit 12.

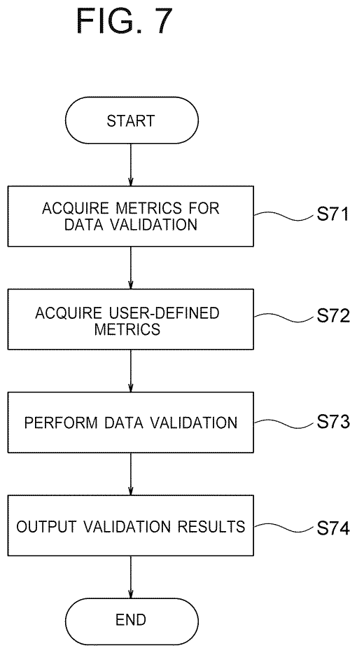

The data validation metrics applied to the data set by the data validation unit 15 are metrics for validating data of the data set item by item (i.e., metrics for validating the validity of data of the data set per data item). Thus, the data validation unit 15 validates data for each data item in the data set. The data validation unit 15 may perform processes of applying a plurality of data validation metrics to the data set in parallel in the pipeline processing. The details of the data validation processing will be described below with reference to FIG. 7.

The data collection unit 16 acquires the processing results of the data quality analysis processing for the data set output from the data quality analysis unit 14 and the data validation processing for the data set output from the data validation unit 15, and stores those data set processing results in the data set processing history 5.

The data collection unit 16 further supplies the data set processing history 5 to the metric construction unit 13. The data set processing history 5 collected by the data collection unit 16 is referred to by the metric construction unit 13 and used as parameters for dynamically reconstructing the data quality analysis metrics and data validation metrics.

The database output unit 17 outputs the data set extracted by the data set extraction unit 12 to the integrated database 4. The database output unit 17 may convert the extracted data set into a desired format, e.g., in the form of multiple interrelated tables in a hierarchical structure, in accordance with the requirements of downstream customer analysis and forecasting and other applications that process the integrated database 4.

The database output unit 17 may exclude, as error data, the entire data set or part of the data set or the data items concerned that fall outside the threshold values set for each metric applied, from the target to be output to the integrated database 4, among the processing results of the data quality check processing by the data quality analysis unit 14 and the data validation processing by the data validation unit 15. In this case, the error data concerned does not constitute the integrated database 4, while it is output as error data to the data set processing history 5.

The orchestrator 18 performs the workflow for constructing the integrated database 4 and performs various settings, management, and adjustments in the workflow execution. According to the present embodiment, the data observation workflow performed by the data observation apparatus 1 is added to the integrated database construction workflow, and the orchestrator 18 also performs various settings, management, and adjustments in the data observation workflow.

More specifically, the orchestrator 18 performs scheduling in the workflow execution by the data observation apparatus 1, issues queries using respective metrics in the data quality check processing and the data validation processing, and performs various error handling processing based on error data output from the data quality check processing and data validation processing.

The orchestrator 18 also controls the pipeline processing in the workflow. More specifically, the orchestrator 18 controls the data quality check processing performed by the data quality analysis unit 14 and the data validation processing performed by the data validation unit 15 to be processed in parallel in the pipeline processing. Furthermore, the orchestrator 18 controls the application of a plurality of quality analysis metrics in the data quality check processing performed by the data quality analysis unit 14 and the application of a plurality of data validation metrics in the data validation processing performed by the data validation unit 15 to be processed in parallel in the pipeline processing, respectively.

<Implementation of Data Observation into Integrated Database Construction Workflow>

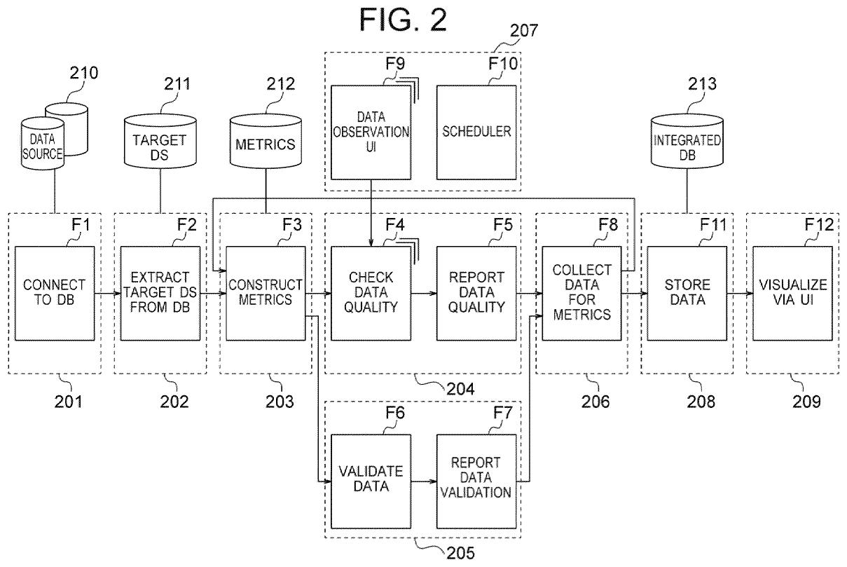

FIG. 2 is a block diagram illustrating an exemplary configuration when the data observation apparatus 1 according to the present embodiment is implemented into the integrated database construction workflow.

Referring to FIG. 2, the integrated database construction workflow includes a data source connector 201, a data set extractor 202, a metric configurator 203, a data quality checker 204, a data validator 205, a data observation client 206, a data collector 207, a data storage 208, and a user interface (i.e., UI) 209, which are incorporated thereto.

The integrated database construction workflow performs, in the pipeline processing, an extraction process to extract a data set to be processed from a plurality of data sources 2, a conversion process to convert the extracted data set into a format for storage in the integrated database 4, and a loading process to load the converted data into the integrated database 4.

According to the present embodiment, each of the components 201 to 209 shown in FIG. 2 may be incorporated at the source code level as a part of the pipeline processing performed by the integrated database construction workflow. Since the data observation function performed by respective components 201 to 209 constitutes a part of the pipelines of the integrated database construction workflow, it makes it possible to eliminate the need for installing a separate virtual machine or server for data observation. Furthermore, it makes it possible to reduce the load on the CPU (Central Processing Unit) or the GPU (Graphics Processing Unit) and memory resources such as RAM (Random Access Memory) when performing the data observation.

Referring to FIG. 2, at F1, the data source connector 201 connects the integrated database construction workflow to a plurality of data sources 210 distributed across a plurality of platforms.

At F2, the data set extractor 202 extracts a target data set to be processed from the databases of a plurality of data sources 210 connected to the workflow by the data source connector 201, and stores the extracted target data set in the data set storage 211, which is constituted with one or more storage devices.

According to the present embodiment, the data set extracted at F2 includes demographic data of customers who use e-commerce sites, in particular including gender, age, residential region, occupation, annual income, educational background, family structure, and the like. At F2, the data set extractor 202 may extract those demographic data along with table names of a plurality of tables constituting the demographic data, the data types of all columns in respective tables, the location of the data, and the like, via an API (Application Programming Interface).

At F3, the metric configurator 203 dynamically constructs the data quality analysis metrics for analyzing the data quality of the data set extracted at F2 and data validation metrics for validating the data in the data set extracted at F2.

More specifically, the metric configurator 203 stores the constructed data quality analysis metrics and the data validation metrics in the metrics storage 212, which is constituted with one or more storage devices. The metric configurator 203 supplies the constructed data quality analysis metrics together with the data set to the data quality checker 204. In parallel, the metric configurator 203 supplies the constructed data validation metrics together with the data set to the data validator 205.

The data quality checker 204 applies (uses) the data quality analysis metrics supplied by the metric configurator 203 to the data set at F4 to analyze the data quality of the data set per data set, and outputs a report of the analysis results of the data quality analysis of the data set at F5. It should be noted that the data set may be constituted with a single table or multiple interrelated tables.

The data quality checker 204 may analyze the data quality of the data set per data set at F4 by a plurality of data quality analysis metrics, each with a different type, to the data set. More specifically, the data quality checker 204 determines that a data set within the thresholds set for the respective data quality analysis metrics is a data set that meets the predetermined data quality criteria for constructing the integrated database 213. On the other hand, the data quality checker 204 determines that a data set outside the thresholds set for the respective data quality analysis metrics is to be error data.

The data validator 205 applies (uses) the data validation metrics supplied by the metric configurator 203 to the data set at F6 to validate the data for each item in the data set, and outputs a report of the data validation results for the data set at F7.

The data validator 205 may apply one or more user-defined data validation metrics to the data set at F6, instead of or in addition to the data validation metrics supplied by the metric configurator 203. The data validator 205 may also perform the data validation of the data set per data item by applying a plurality of data validation metrics, each with a different type, to the data set at F6.

More specifically, the data validator 205 determines that a data item in the data set that is within the thresholds set for the respective data validation metrics is data that meets the predetermined data validation criteria for constructing the integrated database 213. On the other hand, the data validator 205 determines that a data item in a data set that is outside the thresholds set for the respective data validation metrics is to be error data.

The data quality checker 204 and the data validator 205 may concurrently perform the data quality analysis at F4 and the data validation at F6 in parallel. Since the data quality check and the data validation for the data sets do not interfere with or depend on each other, they can be performed concurrently in the integrated database construction workflow so as to improve the throughput of the integrated database construction.

The data collector 206 collects the data quality check results output from the data quality checker 204 and the data validation results output from the data validator 205 at F8 and feeds those results back to the metric configurator 203. The data quality check results and the data validation results collected by the data collector 206 are supplied to the metric configurator 203 as the processing history of the data set and stored in the data set storage 211, and are used for dynamic construction of the metrics performed by the metric configurator 203.

The data collector 206 also supplies the data sets that are determined to be within the effective ranges of the thresholds set for the respective metrics in the data quality check at F4 and the data validation at F6 to the data storage 208.

The data observation client 207 provides an interface to each of the multiple data quality checks at F9 and performs scheduling of each of the workflow components 201 to 209 along with the entire integrated database construction workflow with at F10. The data observation client 207 also issues queries to the data quality checker 204 and the data validator 205, respectively, via the user interface to observe the data quality check transition over time and statistical output using the data quality analysis metrics, and to query the results of the data quality check for a specific data set and data items.

At F11, the data storage 208 stores the data set supplied by the data collector 206 in the integrated database 213 at the back end. The data set to be stored in the integrated database 213 at F11 is the data set that, in the data quality check at F4 and the data validation at F6, meets the criteria set in the respective metrics. Also, the data set to be stored in the integrated database 213 at F11 is data that has been converted to the data structure and data format for the integrated database 213 in the workflow.

The data quality check results and the data validation results collected by the data collector 206 may be stored in the data set processing history 5 in OpenTelemetry format, which is an open source framework for observability, for example. Similarly, the data storage 208 may constitute the integrated database 4 in OpenTelemetry format at F11. In addition, the reporting at F5 and F7 may be output in OpenTelemetry format. This provides a standard API to the data set processing history 5 and the integrated database 4, thereby facilitating processing by third parties and enhancing extensibility.

At F12, the user interface 209 visualizes the processing results, error occurrence status, and the like, in respective processes F1 to F11 performed by the workflow components 201 to 208, respectively. The user interface 209 may provide an appropriate visualization interface depending on a certain phase that needs to be observed in the integrated database construction workflow. For example, the processing results in the data quality check and the data validation can be processed graphically as appropriate to enhance visibility.

### <Detailed Processing Procedure of Data Quality Check Processing>

FIG. 3 is a flowchart illustrating an exemplary detailed processing procedure of the data quality check processing performed by the data observation apparatus 1 according to the present embodiment.

Each step in FIG. 3 is implemented by the CPU reading and executing a program stored in a memory device such as an HDD of the data observation apparatus 1. At least a part of the flowchart shown in FIG. 3 may also be implemented by other hardware such as a GPU. In the case of hardware implementation, for example, a dedicated circuit can be automatically generated on an FPGA (Field Programmable Gate Array) from the program to realize respective steps by using a specified compiler. The Gate Array circuit may also be formed in the same manner as an FPGA and realized as hardware. It may also be realized using an ASIC (Application Specific Integrated Circuit).

The same applies to each of the steps described in FIGS. 7 through 9 below.

In step S31, the data quality analysis unit 14 of the data observation apparatus 1 acquires one or more data quality analysis metrics supplied by the metric construction unit 13. In step S31, the data quality analysis unit 14 may acquire a plurality of data quality analysis metrics of different types.

In step S32, the data quality analysis unit 14 selects a data quality analysis metric for freshness check among a plurality of data quality analysis metrics acquired in step S31, and applies the selected data quality analysis metric for freshness check to the data set to perform the freshness check of the data set.

The freshness check is the process of analyzing the freshness of data. More specifically, in step S32, the data quality analysis unit 14 analyzes how up-to-date the data is. For example, by measuring the time that has elapsed since the data was last updated or integrated, the freshness of the data, i.e., whether the data is updated when it should be updated, can be evaluated.

For example, assume that the customer demographic table needs to be updated on a daily basis. This is because the demographic table is required to be up-to-date as it is the source of data to the many downstream tables derived from this demographic table. For this reason, updating the demographic table is central to making decisions about data across the entire platform. The data quality analysis unit 14 may retrieve information about the freshness of the data via the scheduler in the orchestrator 18 and calculate the freshness of the data using a statistical function.

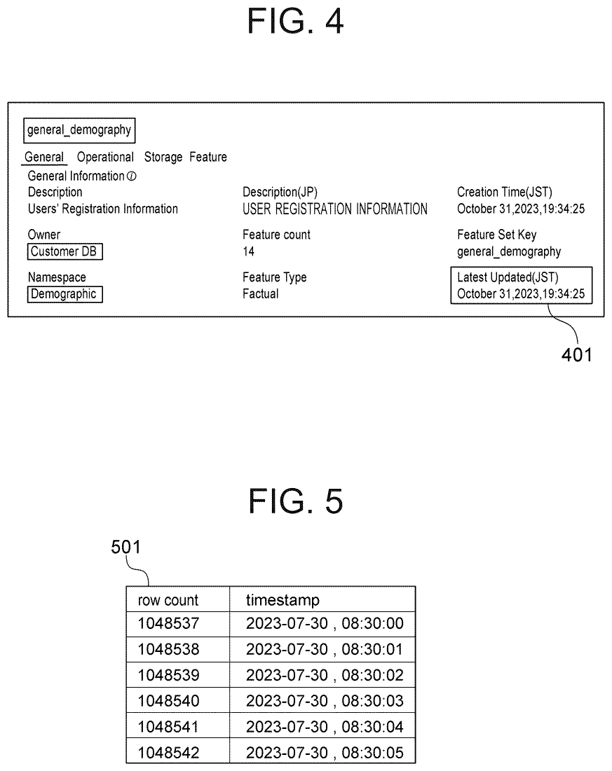

FIG. 4 is a diagram illustrating an example of a screen displaying the results of the freshness check, which is output to the client device via the UI in step S32 of FIG. 3. Referring to FIG. 4, a field 401 on the screen shows the timestamp of when the table “general_demography” of the data set was last updated.

One day (i.e., 24 hours) may be set as the threshold indicating the effective range of the update interval for the data quality analysis metrics for the freshness check. Alternatively, the threshold indicating the effective range may be changed dynamically for the data quality analysis metrics for the freshness check based on the update interval or update frequency of the target data set for a given period of time in the past by referring to the processing history of the data set.

The data quality analysis unit 14 may treat, as error data, data sets that have not been updated for a period of time that exceeds the update interval set in the data quality analysis metrics for the freshness check and may output an alert or error message via the user interface. In this case, the data source 2, which is the source of the customer data, may be notified of the error and prompted to resend the data.

In step S33, the data quality analysis unit 14 selects a data quality analysis metric for volume check from among a plurality of data quality analysis metrics acquired in step S31, and applies the selected data quality analysis metric for the volume check to the data set to perform the volume check.

The volume check is the process of analyzing the amount (or volume) of data that has been generated, integrated, or processed. More specifically, in step S33, the data quality analysis unit 14 analyzes the extent to which the volume of data is increasing or decreasing. For example, the data quality analysis unit 14 may track the daily increase or decrease in the amount of transaction data on the platforms and apply the data quality analysis metrics for the volume check using the effective range of data volume increase or decrease as a threshold. For example, it can be assumed that the number of all users in a customer demographic data does not vary significantly over a short period of time. Therefore, by monitoring the increase or decrease in data volume using the data quality analysis metrics for the volume check, it can be presumed that there has been unintentional duplication or deletion of data across databases when the data volume has increased or decreased significantly over a short period of time. For example, in the volume check of the data set, the data quality analysis unit 14 may monitor the data volume by counting the number of rows in a table concerned.

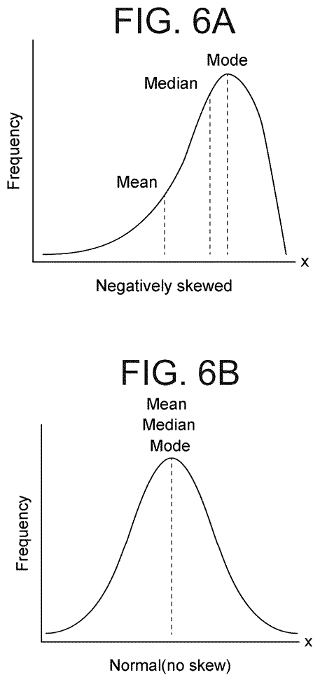

FIG. 5 is a diagram illustrating an example of a screen displaying the results of volume check, which is output to the client device via UI in step S33 of FIG. 3. In the display example shown in FIG. 5, the volume of the data set is acquired with a time stamp of every second, and column 501, which indicates the number of rows of the data set (i.e., number of users), shows that the number of rows of the data set increased from 1,048,537 to 1,048,542 between 8:30:00 and 8:30:05.

A threshold value may be set for the data quality analysis metrics for the volume check to indicate an acceptable range of increase or decrease in the volume of data in the data set. Alternatively, the threshold value indicating the effective range may be dynamically changed for the data quality analysis metrics for the volume check based on the results of monitoring the daily increase or decrease in the volume of the data set by referring to the processing history 5 of the data set in the past.

The data quality analysis unit 14 may treat, as error data, a data set of which data increases or decreases beyond the allowable increase or decrease volume set in the data quality analysis metrics for the volume check, and may output an alert or error message via the user interface. In this case, the data source 2, which is the source of the customer data, may be notified of the error and prompted to resend the data.

In step S34, the data quality analysis unit 14 selects a data quality analysis metric for the data distribution check from a plurality of data quality analysis metrics acquired in step S31, and applies the selected data quality analysis metric for the data distribution check to the data set to perform the data distribution check of the data set.

The data distribution check is the process of analyzing the variance and distribution of the entire data. More specifically, in step S34, the data quality analysis unit 14 analyzes whether the data distribution is balanced or skewed in the data distribution check. The data quality analysis unit 14 may also analyze whether the data distributions of segments in different categories are each sufficiently different from the data distributions of other segments to represent the segment concerned sufficiently.

For example, in the customer demographic data, it can be presumed that the distribution is somewhat even among segments organized by prefecture, age, and gender, i.e., the distribution does not differ significantly among different segments. The data quality analysis unit 14 may periodically track the distribution curves and shifts in the distribution curves of the data distribution and apply the data quality analysis metrics for the data distribution check, for example, with a threshold value of the allowable skew of the data distribution.

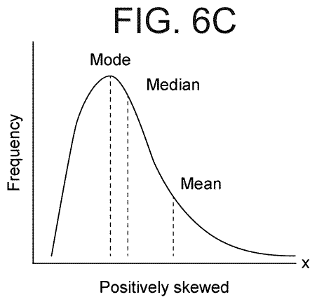

FIGS. 6A to 6C are diagrams each illustrating an example of a screen displaying the results of the data distribution check, which is output to the client device via UI in step S34 of FIG. 3.

FIGS. 6A to 6C show the skew of the data distribution, with the mean, median, and mode of the data plotted, respectively, in each figure.

FIG. 6B shows a non-skewed data distribution with the mean, median, and mode values nearly coinciding. On the other hand, FIG. 6A shows a negatively skewed data distribution with the mean and median shifting negatively from the mode, and FIG. 6C shows a positively skewed data distribution with the median and mean shifting positively from the mode.

By monitoring the degree of skew in the data distribution for the same data set using the data quality analysis metrics for the data distribution check, and by monitoring differences in the skew of the data distribution between different data sets in different segments, it makes it possible to determine data with widely differing distributions due to the existence of outliers, or the like.

A threshold value may be set for the data quality analysis metrics for the data distribution check to indicate an acceptable range of skew in the data distribution of the data set. Alternatively, the threshold indicating the effective range may be dynamically changed for the data quality analysis metrics for the distribution check based on the results of monitoring the daily variation in the data distribution of the data set by referring to the processing history 5 of the data set in the past.

The data quality analysis unit 14 may treat, as error data, a data set of skew increases or decreases beyond the allowable increase or decrease amount set in the data quality analysis metrics for the data distribution check, and may output an alert or error message via the user interface. In this case, the data source 2, which is the source of the customer data, may be notified of the error and prompted to resend the data.

In step S35, the data quality analysis unit 14 selects a data quality analysis metric for schema check from among a plurality of data quality analysis metrics acquired in step S31, and applies the selected data quality analysis metric for the schema check to the data set to perform the schema check of the data set.

The schema check is the process of analyzing the structure and consistency of data. More specifically, in step S35, the data quality analysis unit 14 analyzes whether the data complies with a predefined data model or schema. In order to construct the integrated database of customers appropriately, it is essential that all customers have the same fields and formats to maintain consistency. For example, by monitoring the consistency over time of the multiple columns in the customer demographic table and the data type of each column, it makes it possible to determine changes in the schema of the data. For example, when the data type of a column in the data set changes from integer to floating point number, the data set may be determined to have undergone a schema change.

Columns and their data types of the data set or the tables in the data set may be set to the data quality analysis metric for the schema check. Alternatively, the columns and data types may be changed dynamically for the data quality analysis metric for the schema check based on changes in the schema of the data over a predetermined period of time in the past by referring to the processing history 5 of the data set.

The data quality analysis unit 14 may treat, as error data, a data set with a schema that differs from the columns and their data types set in the data quality analysis metric for the schema check, and may output an alert or error message via the user interface. In this case, the data source 2, which is the source of the customer data, may be notified of the error and prompted to resend the data.

In step S36, the data quality analysis unit 14 selects a data quality analysis metric for the data series check from among a plurality of data quality analysis metrics acquired in step S31, and applies the selected data quality analysis metric for the data series check to the data set to perform the data series check of the data set.

The data series check is the process of tracing the route (or process) from the data source to the data destination. More specifically, in step S36, the data quality analysis unit 14 analyzes the data set or the table name of the data source (e.g., the name of the parent table on which the table concerned was generated) and the data set or the table name of the data destination (e.g., the name of the child table to be generated from the table concerned) described in or associated with the data set.

The fact that the data maintains a predefined data series indicates that the data conversion and processing steps of the data set are transparent and comply with data governance standards. The data series can be obtained by generating a coherent representation of the data flow by referring to upstream tables as the data source and downstream tables as the data destination. For example, the underlying demographic table (i.e., general demography) of the integrated database has inputs from a variety of data sources and is an input to a number of downstream tables. For example, changes in data series can be determined by monitoring for time-series consistency in the coherent representation of data flow in a customer demographic table.

The data series of the data set or the tables in the data set may be set to the data quality analysis metric for the data series check. Alternatively, the data series may be changed dynamically for the data quality analysis metric for the data series check based on changes in the data series over a predetermined period of time in the past by referring to the processing history 5 of the data set in the past.

The data quality analysis unit 14 may treat, as error data, a data set with data series that differ from the coherent representation of the data series set in the data quality analysis metric for the data series check, and may output alerts and error messages via the user interface. In this case, the data source 2, which is the source of the customer data, may be notified of the error and prompted to resend the data.

In step S37, the data quality analysis unit 14 outputs the check results of a plurality of data quality checks performed respectively by applying a plurality of data quality analysis metrics in steps S32 through S36.

Respective data quality checks in steps S32 through S36 shown in FIG. 3 do not necessarily indicate the order of execution. Those multiple data quality checks may be performed simultaneously, in any order, and some of them may not be performed.

Applying the plurality of data quality analysis metrics as described above, it makes it possible to improve data observability in constructing the integrated database and to visualize and identify potential problems such as data stagnation, data spikes, data schema changes, data skew, and gaps in data series. By acting on the data set with those data quality analysis metrics to monitor the quality and time series behavior of the data set, it makes it possible to visually confirm that the data set to be used for constructing integrated database is reliable, accurate, and suitable for subsequent use.

### <Detailed Processing Procedure of Data Validation Processing>

FIG. 7 is a flowchart illustrating an exemplary detailed processing procedure of the data validation processing performed by the data observation apparatus 1 according to the present embodiment.

In step S71, the data validation unit 15 of the data observation apparatus 1 acquires the data validation metrics supplied by the metric construction unit 13. In step S71, the data validation unit 15 may acquire a plurality of data validation metrics of different types.

In step S72, the data validation unit 15 acquires user-defined data validation metrics. The metric construction unit 13 may allow users, via the GUI, to define newly customized data validation metrics for a table or table data item in new data sets. Alternatively, the metric construction unit 13 may allow users, via the GUI, to modify the data validation metrics by reading and editing the already constructed data validation metrics stored in the metrics storage 212.

In step S73, the data validation unit 15 performs the data validation of the data set by applying the data validation metrics acquired in steps S71 and S72, respectively, to the data set.

The data validation is the process of validating the quality, accuracy, and integrity of the values for each data item (i.e., data entries) in the data set or tables within the data set of the target data set. The data validation metrics to be applied in the data validation validate, for each data item, whether the column exists, the data type, the range of data, the uniqueness of the data, whether a null value is entered in a required field, the percentage of data entered, and the like. This will ensure that the data sets to be integrated into the integrated database 4 comply with the desired criteria and requirements.

In step S74, the data validation unit 15 outputs the results of the data validation performed in step S73.

### <Detailed Processing Procedure of Metric Construction Processing>

FIG. 8 is a flowchart illustrating an exemplary detailed processing procedure of the metric construction processing performed by the data observation apparatus 1 according to the present embodiment.

In step S81, the metric construction unit 13 of the data observation apparatus 1 acquires the data set processing history 5 stored in the storage device(s). The data set processing history 5 includes the history of data set(s) extracted from databases of the data sources 2 in the past and the results of data quality check and data validation of the data set(s) collected by the data collection unit 16.

In step S82, the metric construction unit 13 derives, from the data set processing history 5 acquired in step S81, parameters to be set for the data quality analysis metrics to be applied to check the data quality of the data set and the data validation metrics to be applied to validate the data of the data set.

The parameters to be set for the metrics refer to the conditions to be applied in the data quality check and the data validation of the data set(s), and are also referred to as metadata in the present embodiment.

More specifically, for the data quality analysis metrics for the freshness check, the metric construction unit 13 refers to the processing history 5 of the data set in the past, and based on the update interval of the target data set in the past predetermined period, the metric construction unit 13 may derive a predetermined update interval as a parameter.

For the data quality analysis metrics for the volume check, the metric construction unit 13 refers to the processing history 5 of the data set in the past, and based on increase or decrease in the data volume in the target data set (e.g., number of columns in each table) on a daily basis over a predetermined period of time in the past, the metric construction unit 13 may derive a predetermined threshold of increase or decrease in the data volume as a parameter.

For example, assume that the standard deviation of the data volume of the target data set on a daily basis acquired in the past one month is σ. In this case, for example, the data volume of the previous day's target data set±n*σ (n is an integer greater than or equal to 1, e.g., n=3) may each be set as a threshold value in the data quality analysis metrics for the volume check.

For the data quality analysis metrics for the data distribution check, the metric construction unit 13 refers to the processing history 5 of the data sets in the past, and based on the variation of the data distribution in the target data set over a predetermined period in the past, the metric construction unit 13 may derive a predetermined threshold of the variation as a parameter.

For example, assume that the standard deviation of the mean, median, mode, and the like, in the data distribution of the target data set on a daily basis acquired during the past one month is σ, respectively. In this case, all or part of the previous day's mean, median, and mode values±n*σ (n is an integer greater than or equal to 1, e.g., n=3) may be set as threshold values in the data quality analysis metrics for the data distribution check, respectively.

For the data quality analysis metrics for the schema check, the metric construction unit 13 refers to the processing history 5 of the data sets in the past, and may derive columns of the data set or tables in the data set and their data types in the target data set in the past as parameters.

For the data quality analysis metrics for the data series check, the metric construction unit 13 refers to the processing history 5 of the target data set in the past, and may derive the data series of the data set or tables in the data set (e.g., descriptions of upstream and downstream tables from the table concerned) in the target data set over a predetermined period in the past, as parameters.

In step S82, for the data validation metrics, the metric construction unit 13 refers to the processing history 5 of the target dataset in the past, and may derive a predetermined effective range as parameters based on the variation in the values of each column (i.e., each item) of the data set or tables in the data set of the target data set over a predetermined period in the past.

For example, assume that the standard deviation of the average of the mean, maximum, minimum, and standard deviation of the corresponding item in the target data set acquired during the past one month is σ. In this case, for example, the previous value of the target data set±n*σ (n is an integer greater than or equal to 1, e.g., n=3) may be set as the threshold value for the data validation metrics, respectively.

It should be noted that the above values and parameters are no more than examples, and any parameters may be derived from the processing history 5 of the data sets. In addition, each of the above parameters for a plurality of data quality analysis metrics and data validation metrics described above may have default values set in advance.

In step S83, the metric construction unit 13 reflects the parameters derived in step S82 to the corresponding quality analysis metrics and data validation metrics, respectively.

In step S84, the data quality analysis unit 14 applies the data quality analysis metrics, which reflect the parameters derived in step S83, to the data set. Likewise, the data quality analysis unit 14 applies the data validation metrics, which reflect the parameters derived in step S83, to the data set.

This means that in the data quality check processing and the data validation processing, metrics that dynamically reflect the parameters derived from the processing history 5 of the data sets will be applied.

### <Detailed Processing Procedure of Error Handling Processing>

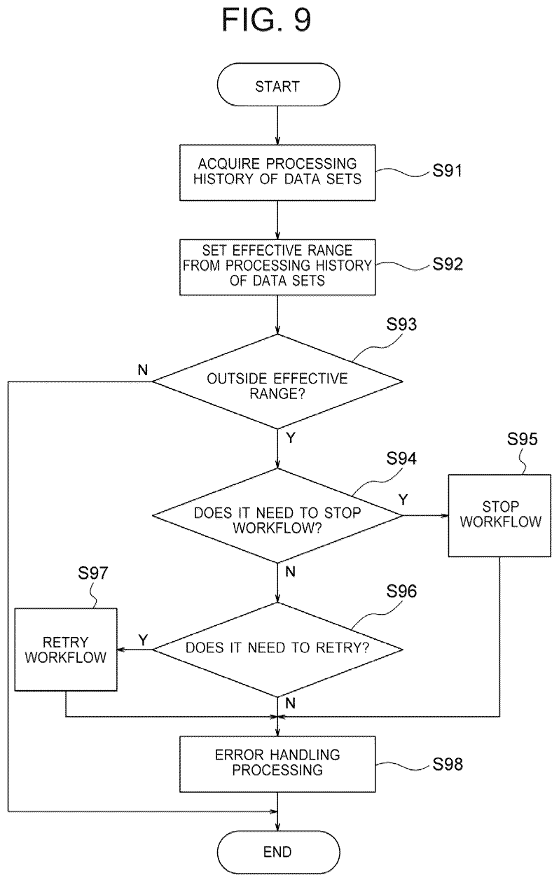

FIG. 9 is a flowchart illustrating an exemplary detailed processing procedure of the error handling processing performed by the data observation apparatus 1 according to the present embodiment.

In step S91, the metric construction unit 13 of the data observation apparatus 1 acquires the data set processing history 5 stored in the storage device(s). The data set processing history 5 includes the history of data sets extracted from the databases of the data sources 2 in the past and the results of the data quality check and the data validation of data sets collected by the data collection unit 16.

In step S92, the metric construction unit 13 derives respective parameters to be set for the data quality analysis metrics and the data validation metrics based on the processing history 5 of the data sets, and sets the derived parameters to the corresponding data quality analysis metrics and the data validation metrics, respectively.

In step S93, the data quality analysis unit 14 applies the data quality analysis metrics parameterized in step S92 to the data set to analyze the data quality of the data set from multiple aspects.

Concurrently, in step S93, the data validation unit 15 applies the data validation metrics parameterized in step S92 to the data set to validate the data entries in the data set. Steps S91 to S93 in FIG. 9 correspond to steps S81 to S84 in FIG. 8, respectively.

When, in step S93, the data set is within the effective range set for the data quality analysis metrics and data validation metrics (step S93: N), the error handling processing is skipped and the data set concerned is stored in the integrated database 4 at a subsequent stage.

On the other hand, when the data set is outside the effective range set for either the data quality analysis metrics or the data validation metrics in S93 (step S93: Y), the data set is determined to have an error and the processing proceeds to step S94.

In step S94, the orchestrator 18 of the data observation apparatus 1 determines whether the integrated database construction workflow needs to be stopped completely due to an error that occurred in the data set. When the integrated database construction workflow needs to be stopped (step S94: Y), the processing proceeds to step S95 and the orchestrator 18 stops the workflow, then the processing proceeds to step S98. On the other hand, when there is no need to stop the integrated database construction workflow (step S94: N), the processing proceeds to step S96.

In step S94, the orchestrator 18 may decide whether to stop the workflow based on whether the component in which the error has occurred is the data quality check or the data validation.

For example, when an error occurs in the data quality check, the orchestrator 18 may stop the workflow because the data quality of the entire data set may be degraded and the impact on data users is expected to be significant. On the other hand, when an error occurs in the data validation, it may be assumed that there are no data quality issues other than the data item in which the error occurred, and the impact on data users is expected to be relatively small, so the orchestrator may continue the extraction, conversion, and loading of the data set into the integrated database without stopping the workflow. As the cases and scope of workflow stoppage may be localized, it makes it possible to improve the availability of the workflow and the integrated database.

In step S96, the orchestrator 18 determines whether the integrated database construction workflow is to be rerun. When the integrated database construction workflow needs to be rerun (step S96: Y), the processing proceeds to step S97 and the orchestrator 18 reruns the workflow after a predetermined time has elapsed and terminates the processing. On the other hand, when the integrated database construction workflow does not need to be rerun (step S96: N), the processing proceeds to step S98.

In step S96, the orchestrator 18 may rerun the workflow to acquire the customer data from the data source 2 and extract the data set again when the error is caused by the data source 2. On the other hand, when the error is not caused by the data source 2, the processing may proceed to step S98 without the orchestrator 18 rerunning the workflow.

In step S98, the orchestrator 18 performs the error handling processing according to the type and degree of the error and terminates the processing.

More specifically, the orchestrator 18 notifies the monitoring entities of the integrated database construction workflow of the error event and the details of the error. At the same time, when the error is caused by the data source 2, the orchestrator 18 notifies the administrator of the data source 2 of the error. The orchestrator 18 may accept the retransmission of the data with the error corrected from the data source 2 that was notified of the error, and extract the data set from the retransmitted data.

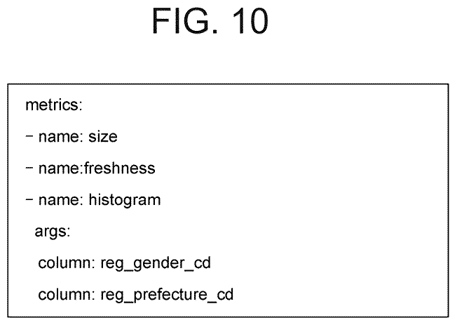

FIG. 10 is a diagram illustrating an example of a description of the data quality analysis metrics set for the data observation apparatus 1 according to the present embodiment.

Referring to FIG. 10, three types of data quality analysis metrics are defined for the data quality analysis metrics. The metric name “size” indicates the data quality analysis metric for the volume check, the metric name “freshness” indicates the data quality analysis metric for the freshness check, and the metric name “histogram” indicates the data quality analysis metric for the data distribution check, respectively. The data quality analysis metric for the data distribution check “histogram” has, as arguments, “reg_gender_cd” to check the data distribution by gender, and “reg_prefecture_cd” to check the data distribution by place of residence (prefecture).

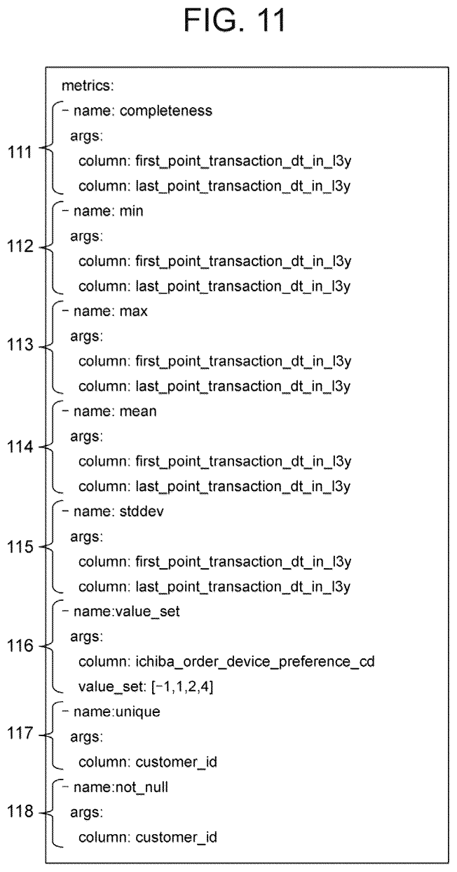

FIG. 11 is a diagram illustrating an example of a description of the data validation metrics set for the data observation apparatus 1 according to the present embodiment.

Referring to FIG. 11, the data validation metrics 111 to 118 are defined, respectively. Each of those data validation metrics 111 to 118 has, as an argument, the name of the target data item to be checked.

The metric named “completeness” checks how much data has been entered. For example, when 90% of data from all customers have entered, the data validation result may be determined as normal. The metric named “min” checks the minimum value of data. The metric named “max” checks the maximum value of the data. The metric named “mean” checks the mean value of the data. The metric named “stddev” checks the standard deviation of the data. For those metrics, thresholds may be dynamically and automatically set to define the effective range and the error range with reference to the processing history of the data set in the past stored in the data set processing history 5, respectively.

The metric named “value_set” checks that the data has a specific value. The metric named “unique” checks that all data values are different from each other within all customers. The metric named “not_null” checks that the data values are not null.

As described above, according to the present embodiment, the data observation apparatus according to the present embodiment extracts a data set from a plurality of customer databases belonging to a plurality of platforms, respectively, applies a first metric to the extracted data set to analyze the data set-by-data set quality of the data set, and applies a second metric to the extracted data set to validate data values for each item in the data set.

The data observation apparatus also dynamically constructs at least a part of the first and second metrics to be applied to the data set based on the processing history of the data set.

Accordingly, it makes it possible to make the accuracy and behavior of data from multiple data sources observable when constructing and updating a database by aggregating data from multiple data sources, thereby improving the accuracy and availability of the data.

### <Hardware Configuration of Data Observation Apparatus>

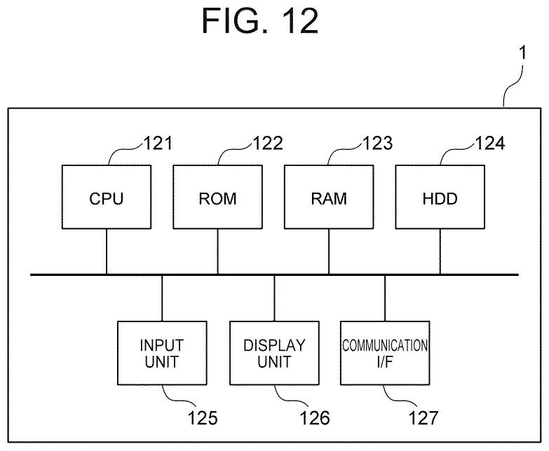

FIG. 12 is a block diagram illustrating a non-limiting example of the hardware configuration of the data observation apparatus 1 according to the present embodiment.

The data observation apparatus 1 according to the present embodiment may be implemented on a single or multiple, any computer, mobile device, or any other processing platform.

Referring to FIG. 12, although the data observation apparatus 1 is shown as being implemented in a single computer, alternatively, the data observation apparatus 1 may be implemented in a computer system including multiple computers. The plurality of computers may be intercommunicatively connected by a wired or wireless network.

As shown in FIG. 12, data observation apparatus 1 may be equipped with a CPU 121, a ROM 122, a RAM 123, an HDD 124, an input unit 125, a display unit 126, a communication I/F 127, and a system bus 128. The data observation apparatus 1 may also be equipped with an external memory.

The CPU (Central Processing Unit) 121 is responsible for overall control of operations in the data observation apparatus 1, and controls respective component 122 to 127 via the system bus 128, which is a data transmission path. It should be noted that, in place of or in addition to CPU 121, the data observation apparatus 1 may be equipped with a GPU (Graphics Processing Unit).

The ROM (Read Only Memory) 122 is a nonvolatile memory that stores control programs, etc. necessary for the CPU 121 to executing processing. The program may be stored in the external memory such as a nonvolatile memory such as an HDD (Hard Disk Drive) 124, an SSD (Solid State Drive), or a removable storage medium (not shown).

The RAM (Random Access Memory) 123 is a volatile memory and functions as the main memory and work area of the CPU 121. In other words, the CPU 121 loads necessary programs, or the like, from the ROM 122 into the RAM 123 when executing processing, and runs the programs, or the like, to realize various functional operations.

The HDD 124 stores, for example, various data, various information, etc. necessary for the CPU 121 to perform processing using the program. The HDD 124 also stores, for example, various data, various information, and the like, acquired by the CPU 121 performing processing using the program, or the like.

The input unit 125 is equipped with a keyboard, mouse, or other pointing device. The display unit 126 is equipped with a monitor device such as a liquid crystal display (LCD). The display unit 126 may provide a Graphical User Interface (GUI), which is a user interface for inputting instructions to the data observation apparatus 1, such as various parameters used in the data observation processing and communication parameters used in communication with other devices.

The communication I/F 127 is an interface that controls communication between the data observation apparatus 1 and external devices.

The communication I/F 127 provides an interface to the network and performs communication with external devices via the network. Via the communication I/F 127, various data, various parameters, and the like, are sent and received to and from the external devices. According to the present embodiment, the communication I/F 127 may perform communication via a wired LAN (Local Area Network) or leased line that conforms to a communication standard such as Ethernet (registered trademark). However, the network available in the present embodiment is not limited to thereto and may consist of a wireless network. The wireless network includes wireless PAN (Personal Area Network) such as Bluetooth (registered trademark), ZigBee (registered trademark), and UWB (Ultra Wide Band). The wireless network also includes wireless LAN (Local Area Network) such as Wi-Fi (Wireless Fidelity) (registered trademark) and wireless MAN (Metropolitan Area Network) such as WiMAX (registered trademark). Furthermore, it includes wireless WAN (Wide Area Network) such as LTE/3G, 4G, and 5G. The network need only be capable of connecting and communicating with each other, and the communication standards, scale, and configuration are not limited to the above.

At least some of the functions of respective components of the data observation apparatus 1 shown in FIG. 1 can be realized by the CPU 121 executing a program. However, at least some of the functions of respective components of the data observation apparatus 1 shown in FIG. 1 may be operated as dedicated hardware. In this case, the dedicated hardware operates under the control of the CPU 121.

While the specific embodiments have been described above, those embodiments are merely an example, and are not intended to limit the scope of the present invention. The apparatuses and methods described in the present specification can be embodied in other forms than those described above. In addition, omissions, substitutions, and changes can be appropriately made to the above-described embodiment without departing from the scope of the present invention. Embodiments with such omissions, substitutions, and changes are included in the scope of what is described in the claims and equivalents thereof, and belong to the technical scope of the present invention.

### EMBODIMENTS OF PRESENT DISCLOSURE

The present disclosure includes the following embodiments:

[1] An information processing apparatus, comprising: a data set extraction unit configured to extract a data set from a plurality of databases belonging to a plurality of platforms, respectively; a quality analysis unit configured to analyze quality of the data set per data set by applying a first metric to the data set; a data validation unit configured to validate a data value per data item in the data set by applying a second metric to the data set; and a metric construction unit configured to dynamically construct at least a part of the first and second metrics to be applied to the data set based on a processing history of the data set.

[2] The information processing apparatus according to [1], further comprising: an orchestrator configured to control the quality analysis unit and the data validation unit to be run in parallel in pipeline processing.

[3] The information processing apparatus according to [2], wherein the quality analysis unit applies a plurality of first metrics mutually different from each other to the data set, and the orchestrator controls the quality analysis unit to apply the plurality of first metrics to the data set in parallel in pipeline processing.

[4] The information processing apparatus according to [2] or [3], wherein the data validation unit applies a plurality of second metrics mutually different from each other to the data set, and the orchestrator controls the data validation unit to apply the plurality of second metrics to the data set in parallel in pipeline processing.

[5] The information processing apparatus according to any of [2] to [4], wherein, the orchestrator causes, when an error occurs in the quality analysis unit, the data set extraction unit to stop extracting the data set, and causes, when an error occurs in the data validation unit, the data set extraction unit to continue extracting the data set.

[6] The information processing apparatus according to any of [1] to [5], wherein the metric construction unit dynamically sets a threshold to at least a part of the first and second metrics based on a standard deviation derived from the processing history of the data set for a prescribed period of time.

[7] The information processing apparatus according to any of [1] to [6], wherein the metric construction unit dynamically constructs a plurality of first metrics to allow changes in the data set over time to be observed in units of data set.

[8] The information processing apparatus according to [7], wherein the metric construction unit dynamically constructs the plurality of first metrics to cause changes over time in at least two or more of freshness, volume, distribution, schema, and data series of the data set to be observed in units of data set.

[9] The information processing apparatus according to any of [1] to [8], further comprising: a user interface configured to query processing results from the quality analysis unit and the data validation unit and set thresholds for the first and second metrics, respectively.

[10] An information processing method performed by an information processing apparatus, comprising steps of: extracting a data set from a plurality of databases belonging to a plurality of platforms, respectively; analyzing quality of the data set per data set by applying a first metric to the data set; validating a data value per data item in the data set by applying a second metric to the data set; and dynamically constructing at least a part of the first and second metrics to be applied to the data set based on a processing history of the data set.

[11] A non-transitory computer-readable medium having recorded thereon an information processing program for causing a computer to perform information processing, the program causing the computer to perform: a data set extraction process of extracting a data set from a plurality of databases belonging to a plurality of platforms, respectively; a quality analysis process of analyzing quality of the data set per data set by applying a first metric to the data set; a data validation process of validating a data value per data item in the data set by applying a second metric to the data set; and a metric construction process of dynamically constructing at least a part of the first and second metrics to be applied to the data set based on a processing history of the data set.

### REFERENCE SIGNS LIST

1: Data Observation Apparatus; 2: Data Source; 3: Client Device; 4: Integrated Database; 5: Data Set Processing History; 11: Data Acquisition Unit; 12: Data Set Extraction Unit; 13: Metric Construction Unit; 14: Data Quality Analysis Unit; 15: Data Validation Unit; 16: Data Collection Unit; 17: Database Output Unit; 18: Orchestrator; 121: CPU; 122: ROM; 123: RAM; 124: HDD; 125: Input Unit; 126: Display Unit; 127: Communication I/F; 128: System Bus; 201: Data Source Connector; 202: Data Set Extractor; 203: Metric Configurator; 204: Data Quality Checker; 205: Data Validator; 206: Data Collector; 207: Data Observation Client; 208: Data Storage; 209: User Interface

What is claimed is:

1. An information processing apparatus, comprising:
a data set extraction unit configured to extract a data set from a plurality of databases belonging to a plurality of platforms, respectively;
a quality analysis unit configured to analyze quality of the data set per data set by applying a first metric to the data set;
a data validation unit configured to validate a data value per data item in the data set by applying a second metric to the data set; and
a metric construction unit configured to dynamically construct at least a part of the first and second metrics to be applied to the data set based on a processing history of the data set.

2. The information processing apparatus according to claim 1, further comprising:
an orchestrator configured to control the quality analysis unit and the data validation unit to be run in parallel in pipeline processing.

3. The information processing apparatus according to claim 2, wherein
the quality analysis unit applies a plurality of first metrics mutually different from each other to the data set, and
the orchestrator controls the quality analysis unit to apply the plurality of first metrics to the data set in parallel in pipeline processing.

4. The information processing apparatus according to claim 2, wherein
the data validation unit applies a plurality of second metrics mutually different from each other to the data set, and
the orchestrator controls the data validation unit to apply the plurality of second metrics to the data set in parallel in pipeline processing.

5. The information processing apparatus according to claim 2, wherein,
the orchestrator causes, when an error occurs in the quality analysis unit, the data set extraction unit to stop extracting the data set, and causes, when an error occurs in the data validation unit, the data set extraction unit to continue extracting the data set.

6. The information processing apparatus according to claim 1, wherein
the metric construction unit dynamically sets a threshold to at least a part of the first and second metrics based on a standard deviation derived from the processing history of the data set for a prescribed period of time.

7. The information processing apparatus according to claim 1, wherein
the metric construction unit dynamically constructs a plurality of first metrics to allow changes in the data set over time to be observed in units of data set.

8. The information processing apparatus according to claim 7, wherein
the metric construction unit dynamically constructs the plurality of first metrics to cause changes over time in at least two or more of freshness, volume, distribution, schema, and data series of the data set to be observed in units of data set.

9. The information processing apparatus according to claim 1, further comprising:
a user interface configured to query processing results from the quality analysis unit and the data validation unit and set thresholds for the first and second metrics, respectively.

10. An information processing method performed by an information processing apparatus, comprising steps of:
extracting a data set from a plurality of databases belonging to a plurality of platforms, respectively;
analyzing quality of the data set per data set by applying a first metric to the data set;
validating a data value per data item in the data set by applying a second metric to the data set; and
dynamically constructing at least a part of the first and second metrics to be applied to the data set based on a processing history of the data set.

11. A non-transitory computer-readable medium having recorded thereon an information processing program for causing a computer to perform information processing, the program causing the computer to perform:
a data set extraction process of extracting a data set from a plurality of databases belonging to a plurality of platforms, respectively;
a quality analysis process of analyzing quality of the data set per data set by applying a first metric to the data set;
a data validation process of validating a data value per data item in the data set by applying a second metric to the data set; and
a metric construction process of dynamically constructing at least a part of the first and second metrics to be applied to the data set based on a processing history of the data set.
